(19) United States
(12) Patent Application Publication
(10) Pub. No.: US 2004/0266425 A1
(43) Pub. Date: Dec. 30, 2004

(54) Wireless wide area network charger and cradle

(75) Inventors: Brian Gonsalves, Antioch, CA (US); Kenneth Roger Jones, Cool, CA (US)

Correspondence Address: TOLER & LARSON & ABEL L.L.P., 5000 PLAZA ON THE LAKE STE 265, AUSTIN, TX, 78746, US

(73) Assignee: SBC, Inc.

(21) Appl. No.: 10/602,552

(22) Filed: Jun. 24, 2003

(51) Int. Cl. H04Q 7/20

(52) U.S. Cl. 455/426.2

(57) ABSTRACT

An apparatus and method for utilizing a telephone docking apparatus is disclosed. The apparatus includes a wireless wide area network telephone, e.g., PCS telephone, and a wireless local area telephone interface. In addition, the disclosed PCS telephone docking apparatus includes battery chargers, a speakerphone, a visual display, a USB interface, and a media reader/writer interface. To receive or make a PCS telephone call from the cordless telephone, a user places their PCS telephone in the PCS telephone docking apparatus, and uses the wireless local area telephone to receive or make calls. Text messages and images may also be transferred to/from the PCS telephone and external devices when using the PCS telephone docking apparatus.

### FIELD OF THE DISCLOSURE

The present disclosure relates generally to telephony.

### DESCRIPTION OF THE RELATED ART

The popularity of wireless wide area network telephony, such as cellular and PCS systems, has grown dramatically in the recent past, and the growth trend shows few signs of abating. Many people currently utilize Personal Communication Services (PCS) telephones, which typically operate in frequency ranges of between 1850 to 1910 MHz, and 1930-1990 MHz. PCS carriers are using Global Systems for Mobile communications (GSM), Personal Access Communications Systems (PACS), as well as TDMA and CDMA technology, among others. In addition to standard calling features such as call forwarding, caller ID, and voice mail, PCS phones can provide other features such as video display and text messaging.

Numerous members of the present generation of young people in America, e.g., teenaged to late twenties, have grown up with PCS telephones, and typically only use PCS telephones, i.e., this generation typically does not own a wired, landline telephone. This situation is even more common in many western European and Asian counties. The standard operationing procedure amongst this generation is to have their PCS phone with them 24×7. When their PCS phones need to be recharged, they plug the PCS phone into a charger at home or at the office. However, a call, text, or video message can be missed during the duration of the charging process, which makes many of these users uncomfortable.

Accordingly, an apparatus, or method that overcomes these problems, would be useful.

### SUMMARY

In a particular embodiment, a wireless wide area network telephone docking apparatus is presented. The wireless wide area network telephone docking apparatus includes a wireless wide area network telephone interface, a transceiver to communicate with a wireless local area telephone, and a first control module to transfer a call received at the wireless wide area network telephone interface to the transceiver. In an embodiment, the first control module transfers the call when a wireless wide area network telephone is coupled to the wireless wide area network telephone interface. In a particular embodiment, the wireless wide area network telephone is a personal communication services (PCS) telephone.

In an embodiment, the wireless local area telephone includes a wireless local area handset. In another embodiment, the wireless local area telephone includes a desktop telephone. In a particular embodiment, the wireless local area telephone has a visual display window. In a specific embodiment, the transceiver includes an antenna assembly responsive to a driver. The driver serves to communicate with the local area telephone, which may be 2.4 GHz, or 5.8 GHz.

In a further embodiment, the docking apparatus includes a speaker, and a second control module to provide the incoming voice portion of a call received at the wireless wide area network telephone interface to the speaker, as well as to provide incoming voice received at the wireless wide area network telephone interface. In another embodiment, the docking apparatus includes a microphone and a second control module to provide an outgoing voice portion received at the microphone to the wireless wide area network interface. In other embodiments, the docking apparatus includes an alphanumeric keypad and a visual display. The visual display is responsive to the alphanumeric keypad, as well as to text messages from the wireless wide area network telephone. The visual display may also be responsive to the wireless local area telephone.

In a particular embodiment, the visual display is a liquid crystal display (LCD) capable of displaying video images from an image-capable wireless wide area network telephone, and capable of displaying text messages from the wireless wide area network telephone. In further embodiments, the docking apparatus includes a battery charger for charging a battery in the wireless wide area network telephone, and a battery charger for charging a battery in the wireless local area telephone.

In another embodiment, the docking apparatus includes a first data interface of a first type to communicate with a first type of external device, and a second data interface of a second type to communicate with a second type of external device. In various embodiments, the external devices may be a personal computer (PC), a camera, a personal data assistant (PDA), or a digital storage card. In an embodiment, the first data interface may be a universal serial bus (USB) interface, while the second data interface may be a portable media reader and/or writer interface.

In a particular embodiment, a method for relaying wireless wide area network telephone calls to a wireless local area telephone is presented. The method includes receiving an incoming call signal from a wireless wide area network telephone at a base station, and initiating communication from the base station to a wireless local area telephone in response to receiving the incoming call signal. In an embodiment, the method further includes charging the wireless local area telephone from the base station.

In another embodiment, the method includes communicating with an external device through a first standardized interface, which may be a universal serial bus (USB) standardized interface. In other embodiments, the external device may be a personal computer or a camera. In a further embodiment, the method includes communicating with an external device through a second standardized interface. The second standardized interface may be a portable media reader/writer, in embodiments where the external device is a digital storage card.

In a particular embodiment, a method is presented for receiving an outgoing call request signal at a base station from a wireless local area telephone, and initiating, from the base station, a call to be made from a wireless wide area network telephone, in response to receiving the outgoing call request signal. In various embodiments, the method includes charging the wireless local area telephone and the wireless wide area network telephone from the base station. In further embodiments, the method includes communicating with an external device through a first standardized interface. The first standardized interface may be a USB interface, and the external device may be a PC or a camera. In particular embodiments, the method includes communicating with an external device through a second standardized interface, which may be a portable media reader/writer interface. The external device may be a digital storage card.

In a further embodiment, an apparatus comprising a first location to interface with a wireless wide area network telephone and a second location to interface with a wireless local area telephone is presented. The apparatus further includes a first charging portion to provide a charging signal to the first location to charge the wireless wide area network telephone, and a second charging portion to provide a charging signal to the wireless local area telephone. In an embodiment, the wireless wide area network telephone may be a PCS telephone. In a particular embodiment, the wireless local area telephone may be a wireless local area telephone handset, or may be a desktop telephone.

### BRIEF DESCRIPTION OF THE DRAWINGS

FIG. 1 is a general diagram illustrating a wireless wide area network telephone docking apparatus with wireless local area telephone support and battery chargers;

FIG. 2 is a block diagram illustrating an embodiment of a telephone docking apparatus with a range of features;

FIG. 3 is a flow diagram illustrating a method for relaying wireless wide area network telephone calls to a wireless local area telephone; and

FIG. 4 is a flow diagram illustrating a method of relaying wireless wide area network telephone calls from a wireless local area telephone to the wireless wide area network telephone.

### DESCRIPTION OF THE DRAWINGS(S)

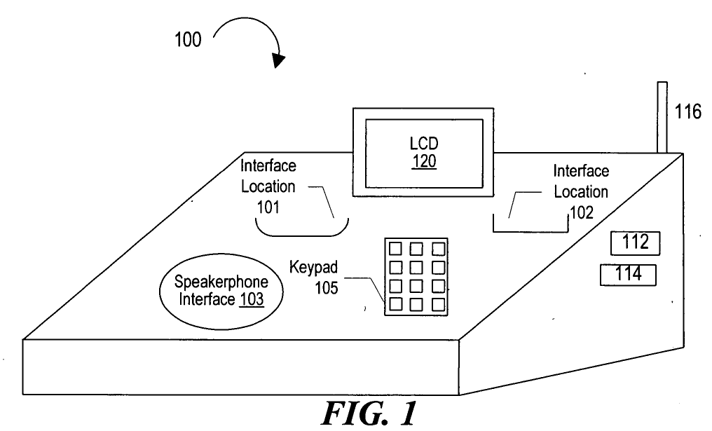

The present disclosure is generally directed to wireless wide area network telephony, and specifically to a wireless wide area network telephone battery-charging cradle with wireless local area telephone communications support, and various other features such as visual display capabilities and speakerphone. In a particular embodiment, the wireless wide area network telephone may be a personal communication services (PCS) telephone, however, the present disclosure should not be construed as being limited to PCS telephones. The method and apparatus disclosed herein would be suitable for other types of wireless wide area telephones as well. This disclosure may be better understood with reference to FIGS. 1 through 4.

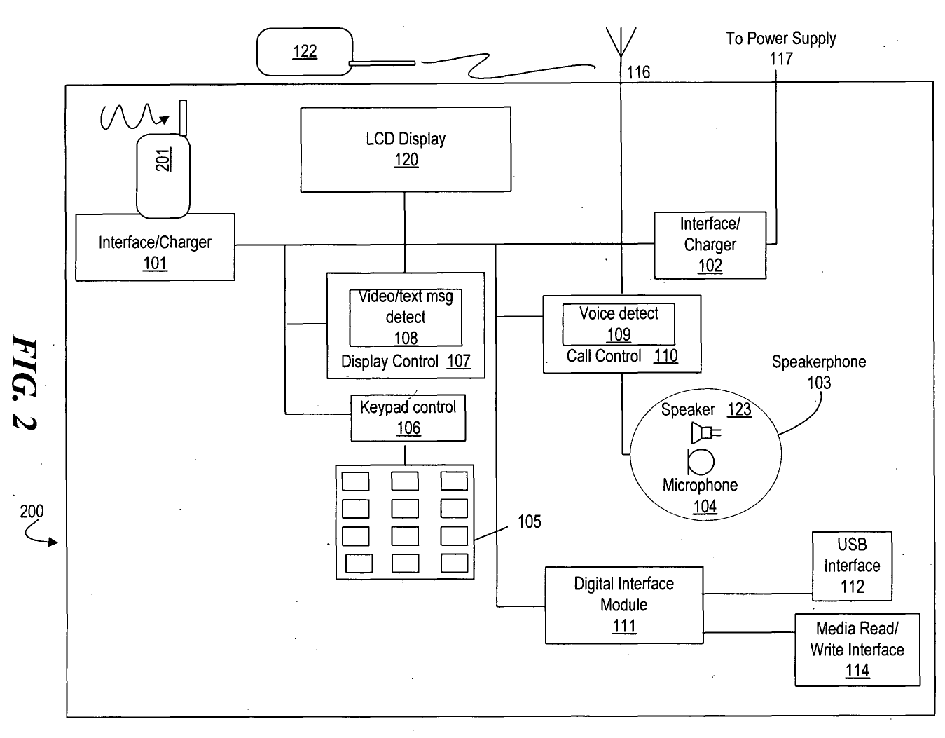

FIG. 1 is a general diagram illustrating a wireless wide area network telephone docking apparatus 100 with wireless local area telephone support and battery charging locations. The wireless wide area network telephone docking apparatus 100 includes a wireless wide area network telephone interface port that includes a connection for charging the battery of a wireless wide area network telephone (201 in FIG. 2), a wireless local area telephone interface 102 which may include connections to a battery charger and an antenna 116 coupled to a transceiver (not shown) to communicate with a wireless local area telephone (122 in FIG. 2). The transceiver in docking apparatus 100 includes an antenna assembly 116 which is responsive to a driver (not shown). The driver is used to communicate with the wireless local area telephone. This communication occurs at a frequency of approximately 2.4 GHz, 5.8 GHz, or other frequency to carry out the communication with the wireless local area telephone, e.g., 900 MHz.

The wireless wide area network telephone docking apparatus further includes a standardized media reader and/or writer interface 114 responsive to an external device, a speakerphone 103 that includes a speaker and a microphone, an alphanumeric keypad 105, a standardized universal serial bus (USB) interface 112, and a visual display 120. The standardized USB interface 112 is responsive to external USB devices such as a personal computer (PC), camera, a personal data assistant (PDA), or other USB devices which typically utilize a cable with USB fittings to send and/or receive serial data to and/or from telephone docking apparatus 100 to/from the external USB device.

In an embodiment, visual display 120 may be a liquid crystal display (LCD) capable of displaying video images such as video images from a PCS video telephone docked in telephone docking apparatus 100. The visual display 120 can also be used to display images from an external USB device connected to the standardized USB interface 112, or alphanumeric text messages received from a wireless wide area network telephone while docked in the telephone docking apparatus 100. In addition, visual display 120 may be used to display keystrokes entered by a user from the alphanumeric keypad 105. In an alternate embodiment, the visual display may also reside on the wireless local area telephone 201 (not shown) to provide some or all of the visual effects of the display 120.

FIG. 2 is a block diagram illustrating an embodiment of a wireless wide area network telephone docking apparatus 200 with a range of features. Docking apparatus 200 may also be referred to as base station 200. Telephone docking apparatus 200 features a wireless wide area network telephone interface 101 for charging a wireless wide area network telephone 201, as well as for providing access to the other feature modules within the docking apparatus 200. In addition, base station 200 contains an interface/charger 102 for charging a battery in a wireless local area telephone 122. In an embodiment, the wireless wide area network telephone 201 is a PCS telephone. Wireless local area telephone 102 can be a wireless local area handset, a wireless local area telephone having a handset, or a desktop telephone.

Other modules in the base station include display control module 107, call control module 110, a digital interface module 111 and keypad control module 106. Each of the modules 106, 107, 110, and 111 are coupled to the interface 101 to monitor and/or receive data to be handled by each specific module. While the connection to the interface 101 is illustrated as a common connection, such as a bus, it will be appreciated that other connections would be anticipated herein.

In operation, display control module 107 monitors information received at the interface 101, the keypad 105, and the digital interface module 111 to determine when information has been received that should be displayed on the LCD display 120. The call control module 110 monitors information received from the wireless wide area network phone 201 at the interface 101 that is to be communicated to the wireless local area telephone 122 via the antenna 116, and/or to the speaker phone 103. Digital interface module 111 monitors information received at the interface 101 to determine when received data is to be provided to one of the interfaces 112 and 114, and conversely, module 111 provides data received at the interfaces 112 and 114 to one or more of the modules 101, 107, and 110.

The portable media read/write interface 114 serves as a standardized input/output interface for communicating with portable external devices, e.g., digital storage cards, also known as media read/write sticks. Examples of digital storage cards are the Smart Media card or CompactFlash card. The media read/write interface 114, in conjunction with digital interface module 111, enables transfer of data, e.g., images, from the external devices to LCD display 120, and to a display window (not shown) in the wireless wide area network telephone 201.

Other external devices can be connected to the standardized universal serial bus (USB) interface 112 to transfer data, e.g., images, text, telephone numbers, and the like, to the digital interface module 111, which then migrates the data to a wireless wide area network telephone 201 in the interface/charger location 101 of docking apparatus 200. Examples of external devices which may utilize USB interface 112 include a personal computer (PC), a camera, a personal data assistant (PDA), a dialer, and the like.

As part of its call transfer capabilities, the apparatus 200 of FIG. 2 facilitates a frequency conversion. When an incoming wireless wide area network telephone call is received by a wireless wide area network telephone 201 docked in docking apparatus 200, the call is received based on a first protocol, such as a PCS protocol, at a first frequency. This call is ultimately communicated to the wireless local phone at a different frequency, using a different protocol and frequency.

The call control module 110 utilizes a radio frequency driver to communicate with the wireless local area telephone 122 at approximately 2.4 GHz, 5.8 GHz, or other frequency, e.g., 900 MHz. In this way the frequency of the incoming wireless wide area telephone call is converted from the frequency of the wireless wide area telephone to another frequency, e.g., that of the wireless local area telephone. The incoming call with the converted frequency is then relayed to the antenna 116 for transmission to the wireless local area telephone 122. The transfer/relay process preferably appears seamless to the user of the docking apparatus.

If the incoming wireless wide area network call is a text message or video image, docking apparatus 200 can display the message or image on visual display 120. The process is facilitated by the display control module 107 and the video/text message detection module 108, which detects when text information is to be displayed. A keypad control module 106 is also connected to an alphanumeric keypad 105, such that a user's keystrokes on keypad 105 can be detected and displayed in the visual display 120 and control the telephone 201 or 122. Similarly, keystrokes on the wireless local area telephone 122 can be detected by the display control module 107 and displayed by LCD display 120.

A speakerphone 103 with a speaker 123 and a microphone 104 is also provided so that a user of the base station 200 has a “hands-free” option when receiving or making a voice call. Typically, one portion of call controller 110 will interface with the speakerphone 103, while a second portion of call controller 110 will interface with the antenna 116. A power supply line 117 provides power to the base station 200. Power supply line 117 may a 110/220 VAC auto sense transformer which plugs into a wall receptacle to supply 12-volt DC power to the base station 200.

It will be appreciated that other components may be incorporated into the telephone docking apparatus 200 which are not specifically illustrated herein. Examples of other components can include proprietary or non-proprietary interfaces to allow communication to devices to permit coordination of telephone information, or to provide automated dialing. Functions to perform voice processing, call processing, and logic and/or protocol processing, would then be provided by the telephone docking apparatus 200.

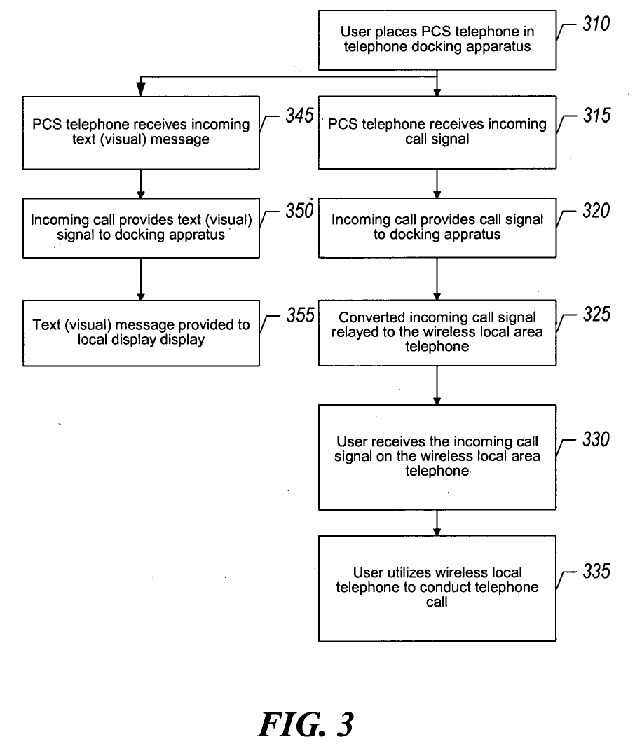

FIG. 3 is a flow diagram illustrating a method for relaying wireless wide area network telephone calls to a wireless local area telephone. For purposes of example, the wireless wide area network telephone will be discussed in conjunction with FIG. 3 as a PCS telephone. The PCS telephone is placed in the PCS telephone docking apparatus by the PCS telephone user in step 310. This will start the charging process for the PCS telephone battery, but also enables the user to receive incoming PCS telephone calls with the wireless local area telephone interfaced with the telephone docking apparatus.

In step 315, the PCS telephone receives an incoming call signal from a PCS network at the base station. At step 320, a representation of an incoming call is provided to the docking apparatus 200 through the interface 101. At step 325, modules within the docking apparatus, in response to the receiving the representation of the incoming call converts the call to an outgoing call signal to the wireless local area telephone. At step 330, the user receives the incoming call on the wireless local area telephone. Preferably, the conversion and transfer/relay processes are seamless to the user, who, in step 335, answers the telephone call using the wireless local area telephone to conduct a telephone conversation.

Step 345 indicates that the PCS telephone has received a visual message, such as a text message. At step 350, a representation of the text message has been provided to the connector of the docking apparatus. At step 355, the representation of the text message has been detected by the docking apparatus and provided to a local display associated with the docking apparatus, or the wireless local area telephone.

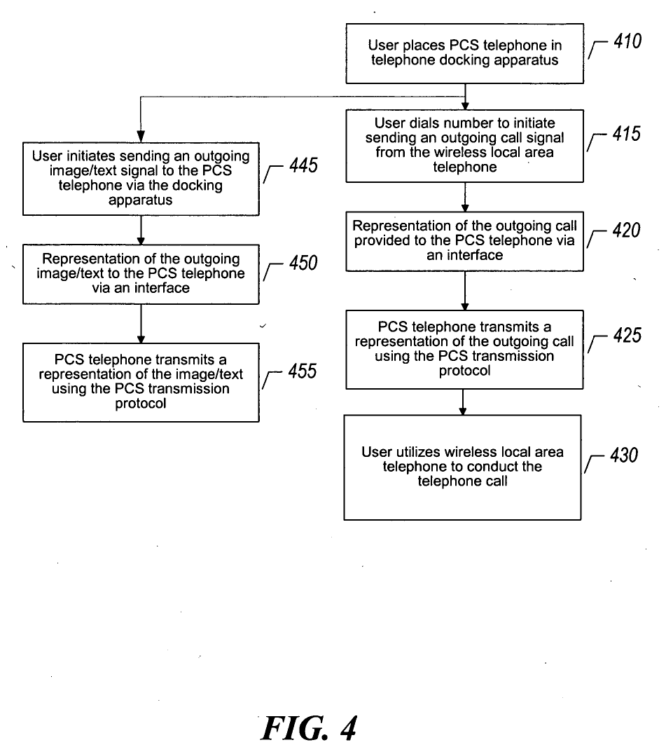

A specific advantage of the embodiment described herein is that when a user wishes to charge a battery in their PCS telephone, they are still able to receive and make calls using their PCS phone by physically using the wireless local area telephone in lieu of the PCS telephone. A process of initiating calls from the wireless local area telephone is presented in FIG. 4. A flow diagram illustrating a method of relaying PCS telephone calls from a wireless local area telephone to a wireless wide area network telephone, such as a PCS telephone, is disclosed.

In step 410, a user places a PCS telephone in the PCS telephone docking apparatus. The user removes the wireless local area telephone from the docking apparatus/charger and dials a number, either on the keypad of the cordless telephone, or on the alphanumeric keypad of the PCS telephone docking apparatus.

In response to the number input, an outgoing call signal is initiated from the cordless telephone, as in step 415. In step 420, the outgoing call, after being received at the docking station, provides a representation of the outgoing call to the PCS telephone via an interface, such as interface 101 of FIG. 2. At step 425, the PCS telephone transmits a representation of the outgoing call using the PCS transmission protocol. Finally, in step 430, the user utilizes the wireless local area telephone to make the PCS telephone call, since relaying continues until an off-hook signal is received from the user of the cordless telephone, e.g., the user presses the “Off” or “End” key on the wireless local area telephone to terminate the call.

As with incoming text messages from the PCS telephone, the telephone docking apparatus may also be utilized to relay outgoing text messages in a similar fashion to that of sending an outgoing call signal. Outgoing text messages would typically be displayed in the visual display window of the PCS telephone docking apparatus as part of the process of being relayed to the PCS telephone for transmission via a wireless wide area network. The wireless wide area network telephone apparatus is also capable of transferring images to or from an image-capable PCS telephone via various interfaces, as discussed in conjunction with steps 445-455 of FIG. 4.

At step 445, the user initiates the transfer of an outgoing image or text from the wireless local area telephone, or a peripheral device, such as a camera or general purpose computer, that is coupled to an interface port, such as a USB port. At step 450, the image or text, is provided to the image-capable PCS telephone for display, storage or transmission. In a particular embodiment, the external device is a personal computer. In other embodiments, the external device may be a personal data assistant, a camera, or another storage device such as a personal data assistant (PDA). At step 455, a communication signal can be transmitted to the image capable PCS telephone to facilitate transmitting the image or text to another device, which may be another image capable PCS telephone.

The apparatus and methods described herein provides for a flexible implementation. Although embodiments of the invention have been described using certain specific examples, it will be apparent to those skilled in the art that the invention is not limited to these few examples. Additionally, various types of PCS telephones and cordless telephones are currently available which could be suitable for use in the docking apparatus for relaying PCS communications when employing the methods and apparatus as taught herein. The above-disclosed subject matter is to be considered illustrative, not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus comprising:
a wireless wide area network telephone interface;
a transceiver to communicate with a wireless local area telephone; and
a first control module to transfer a call received at the wireless wide area network telephone interface to the transceiver.

2. The apparatus of claim 1, wherein the first control module transfers the call when a wireless wide area network telephone is coupled to the wireless wide area network telephone interface.

3. The apparatus of claim 1, wherein the wireless local area telephone comprises a wireless local area handset.

4. The apparatus of claim 1, further comprising a wireless local area telephone having a visual display window.

5. The apparatus of claim 4, wherein the wireless local area telephone comprises a desktop telephone.

6. The apparatus of claim 1, wherein the transceiver includes an antenna assembly responsive to a driver.

7. The apparatus of claim 6, wherein the driver is to communicate with the wireless local area telephone at approximately 2.4 GHz.

8. The apparatus of claim 6, wherein the driver is to communicate with the wireless local area telephone at approximately 5.8 GHz.

9. The apparatus of claim 1 wherein the wireless wide area network telephone is a PCS telephone.

10. The apparatus of claim 1, further comprising:
a speaker;
a second control module to communicate an incoming voice portion of the call received at the wireless wide area network telephone interface to the speaker.

11. The apparatus of claim 1, further comprising:
a microphone; and
the second control module to provide an outgoing voice portion received at the microphone to the wireless wide area network interface.

12. The apparatus of claim 11, further comprising an alphanumeric keypad.

13. The apparatus of claim 12, further comprising a visual display.

14. The apparatus of claim 13, wherein the visual display is responsive to the alphanumeric keypad.

15. The apparatus of claim 13, wherein the visual display is responsive to text messages from the wireless wide area network telephone.

16. The apparatus of claim 13, wherein the visual display is responsive to the wireless local area telephone.

17. The apparatus of claim 13, wherein the visual display is a liquid crystal display (LCD) capable of displaying video images from an image-capable wireless wide area network telephone and of displaying alphanumeric text messages from the wireless wide area telephone.

18. The apparatus of claim 1, further comprising a battery charger for charging a battery in the wireless wide area network telephone.

19. The apparatus of claim 1, further comprising:
a battery charger for charging a battery in the wireless wide area telephone; and
a battery charger for charging a battery in the wireless local area telephone.

20. The apparatus of claim 1, further comprising:
a first data interface of a first type to communicate with a first type of external device; and
a second data interface of a second type to communicate with a second type of external device.

21. The apparatus of claim 20, wherein the first type of external device is a personal computer (PC).

22. The apparatus of claim 20, wherein the first type of external device is a camera.

23. The apparatus of claim 20, wherein the first type of external device is a personal data assistant (PDA).

24. The apparatus of claim 20, wherein the first type of external device is a digital storage card.

25. The apparatus of claim 20, wherein the first data interface is a universal serial bus (USB) interface.

26. The apparatus of claim 20, wherein the second data interface is a portable media reader and/or writer interface.

27. A method comprising:
receiving an incoming call signal from a wireless wide area network telephone at a base station; and
initiating communication from the base station to a wireless local area telephone in response to receiving the incoming call signal.

28. The method of claim 27, further comprising charging the wireless wide area network telephone from the base station.

29. The method of claim 28, further comprising charging the wireless local area telephone from the base station.

30. The method of claim 27, further comprising communicating with an external device through a first standardized interface.

31. The method of claim 30, wherein the first standardized interface is a universal serial bus (USB) standardized interface.

32. The method of claim 30, wherein the external device is a personal computer (PC).

33. The method of claim 30, wherein the external device is a camera.

34. The method of claim 27, further comprising communicating with an external device through a second standardized interface.

35. The method of claim 34, wherein the second standardized interface is a portable media reader/writer standardized interface.

36. The method of claim 34, wherein the external device is a digital storage card.

37. A method comprising:
receiving an outgoing call request signal at a base station from a wireless local area telephone; and
initiating from the base station a call to be made from a wireless wide area network telephone in response to receiving the outgoing call request signal.

38. The method of claim 37, further comprising charging the wireless wide area network telephone from the base station.

39. The method of claim 38, further comprising charging the wireless local area telephone from the base station.

40. The method of claim 37, further comprising communicating with an external device through a first standardized interface.

41. The method of claim 40, wherein the first standardized interface is a universal serial bus (USB) standardized interface.

42. The method of claim 40, wherein the external device is a personal computer (PC).

43. The method of claim 40, wherein the external device is a camera.

44. The method of claim 37, further comprising communicating with an external device through a second standardized interface.

45. The method of claim 44, wherein the second standardized interface is a portable media reader/writer standardized interface.

46. The method of claim 44, wherein the external device is a digital storage card.

47. An apparatus comprising:
a first location to interface with a wireless wide area network telephone;
a first charging portion to provide a charging signal to the first location to charge the wireless wide area network telephone;
a second location to interface with a wireless local area telephone; and
a second charging portion to provide a charging signal to the wireless local area telephone.

48. The apparatus of claim 47, wherein the wireless wide area network telephone is a PCS telephone.

49. The apparatus of claim 47, wherein the wireless local area telephone is one of a wireless local area handset and a desktop telephone.
